(19) United States
(12) Patent Application Publication
(10) Pub. No.: US 2008/0244173 A1
(43) Pub. Date: Oct. 2, 2008

(54) STORAGE DEVICE USING NONVOLATILE CACHE MEMORY AND CONTROL METHOD THEREOF

(75) Inventor: YORIHARU TAKAI, Kodaira-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/953,463

(22) Filed: Dec. 10, 2007

(30) Foreign Application Priority Data
Mar. 30, 2007 (JP) 2007-091656

(51) Int. Cl. G06F 12/14; G06F 12/00

(52) U.S. Cl. 711/113; 711/E12.019; 711/E12.001

(57) ABSTRACT

According to one embodiment, the present invention provides a storage device that sophisticatedly utilizes the characteristics of a nonvolatile cache memory and a hard disk, and compensates defects of the hard disk drive side to improve the reliability of the device. The storage device includes a host interface, a command analyzing section, a memory that stores request information which permits or forcibly forbids accessing the hard disk, a device state determining section that determines the request information of the memory, and a media access determining section that, when the determination result of the device state determining section indicates the “forbiddance”, forbids accessing the hard disk, and, when the determination result of the device state determining section indicates the “permission”, permits the accessing based on the analysis result of the command analyzing section and unique determination result.

### CROSS-REFERENCE TO RELATED APPLICATIONS

This application is based upon and claims the benefit of priority from Japanese Patent Application No. 2007-091656, filed Mar. 30, 2007, the entire contents of which are incorporated herein by reference.

### BACKGROUND

1. Field

One embodiment of the invention relates to a storage device using a nonvolatile cache memory and a control method thereof, in which the media access destination or access forbiddance media can be forcibly set up by the storage device side.

2. Description of the Related Art

In recent years, a storage device in which both a cache memory being a semiconductor storage medium and a hard disk (HD) being a magnetic storage medium can be mounted is being developed (for example, refer to a Public Document: Jpn. Pat. Appln. Publication No. 8-123725).

In this device, a cache memory that can be accessed with a high speed is effectively utilized. An upper device (host) temporarily writes data to a cache memory. Then, in the storage device, the write back is performed, under which the data is transferred to a low-speed hard disk from the cache memory.

According to the Public Document, the host sends a notice of accessing the storage device in advance so that the write back operation in the storage device and the timing at which the host accesses the storage device do not overlap mutually. That is, before the data is transferred, the host sends a notice of forbidding the write back operation to the storage device. Furthermore, in case there is a sufficient time interval before accessing the storage device next time, the host sends a notice of permitting the write back operation.

A storage device that uses a plurality of kinds of storage media of different characteristics, or a cache memory and a hard disk, effectively takes advantage of the characteristics of the respective storage media. As the characteristics of the respective storage media, there are the response speed in writing/reading data, rate of rise at the time of turning on power, etc. However, the conventional device sometimes lacks a function of making full use of the characteristics of the respective storage media with respect to the use environment, use situation, and use demand.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an explanatory diagram indicative of an example of using a device to which the present invention is applied;

FIG. 2 shows a block diagram indicative of the entire configuration of one embodiment according to the present invention;

FIG. 3 shows a diagram to explain the characteristics of a flash memory to be used as a nonvolatile cache memory in FIG. 2;

FIG. 4 shows a diagram to explain the function of a flash memory interface and the function of a controller 311 shown in FIG. 2;

FIG. 5 shows a flowchart to explain one example of the operation of the device shown in FIG. 4;

FIG. 6 shows a block diagram indicative of the entire configuration of another embodiment according to the present invention;

FIG. 7 shows a block diagram indicative of the entire configuration of yet another embodiment according to the present invention;

FIG. 8 shows a flowchart to explain one example of the operation of the device shown in FIG. 7;

FIG. 9 shows a flowchart to explain the operation in yet another embodiment according to the present invention; and

FIG. 10 shows a block diagram indicative of the entire configuration of yet another embodiment according to the present invention.

### DETAILED DESCRIPTION

Various embodiments according to the invention will be described hereinafter with reference to the accompanying drawings.

An object of the embodiments of the present invention is to set it up as a prerequisite to sophisticatedly utilize the characteristics of a nonvolatile cache memory and a hard disk as recording media. Then, defects of the hard disk drive side are compensated to improve the reliability of the device.

According to one aspect of the present invention, there is provided a storage device, which includes a host interface, a command analyzing section that analyzes the contents of a command input from the host interface, a hard disk interface connected to a hard disk, a memory that stores request information that permits or forcibly forbids accessing the hard disk, a device state determining section that, before responding to the command analyzed by the command analyzing section, determines the request information of the memory, and a media access determining section that, when the determination result of the device state determining section indicates the “forbiddance”, forbids accessing the hard disk, and, when the determination result of the device state determining section indicates the “permission”, permits accessing the hard disk based on the analysis result of the command analyzing section and unique determination result.

According to the present invention, the state to surely forbid accessing a hard disk can be set up. Accordingly, time periods for accessing a hard disk can be cut off. So, there can be provided a storage device which is robust over the impact, and in which an operation mode capable of reducing time periods for consuming power as much as possible can be set up according to the intention of the user.

### Application Example of Present Invention

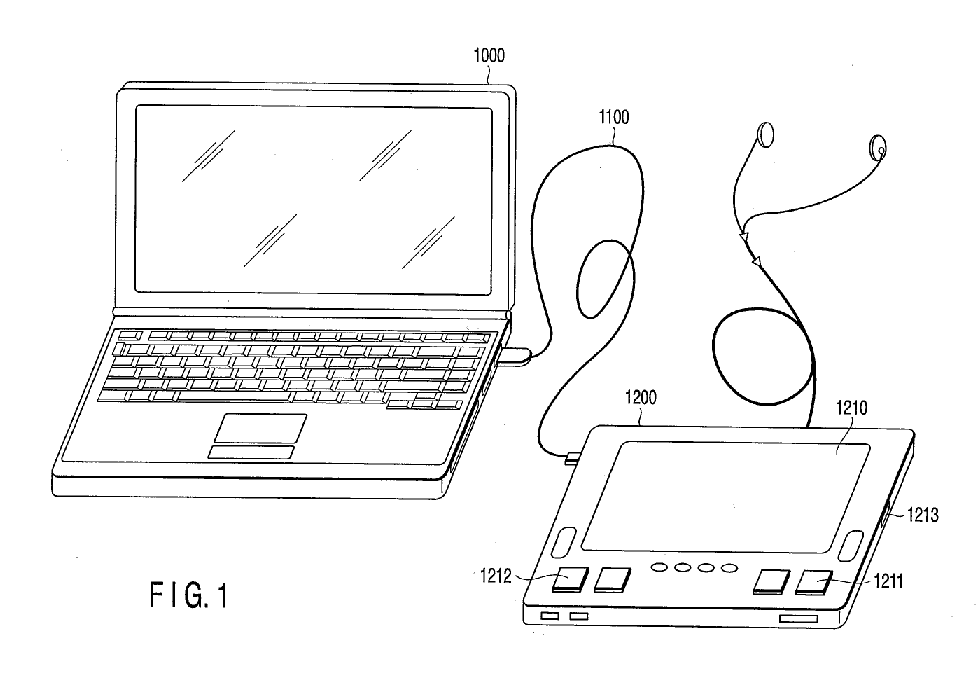

FIG. 1 shows an example of using a device to which the storage device according to the present invention is applied. In FIG. 1, a reference symbol 1000 denotes a personal computer. To the personal computer 1000, for example, a personal digital assistance 1200 can be connected via a USB connection cable 1100. The personal digital assistance 1200 can operate as, for example, a music player or a game machine. The personal digital assistance 1200 has arranged thereon a liquid crystal display 1210, operation buttons 1211, 1212, a switch 1213, etc., and the personal digital assistance 1200 can be operated. The operation buttons, switch, etc. are referred to as an operation section 121A.

<Whole Configuration and Function>

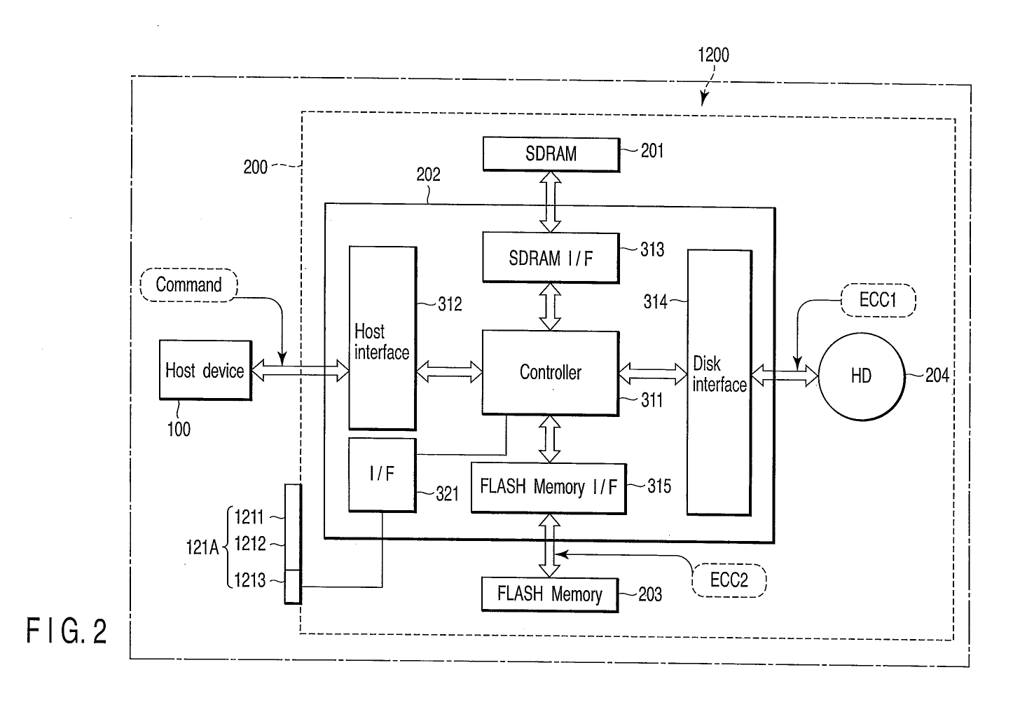

One example of the entire block of one embodiment is explained with reference to FIG. 2. A reference symbol 100 denotes a host device which is a control section in the above-described personal computer. A reference symbol 200 denotes a storage device using a nonvolatile cache memory. The storage device 200 includes an SDRAM 201 functioning as a buffer, a large scale integrated circuit (LSI) 202 of, for example, one-chip on which a controller etc. to be described later are mounted, a flash memory 203 as a nonvolatile cache memory, and a hard disk (HD) 204. These elements are built in the personal digital assistance 1200 shown in FIG. 1.

The LSI 202 includes a controller 311, a host interface 312, an SDRAM interface 313, a disk interface 314, a flash memory interface (which may be referred to as cache memory interface) 315. The LSI 202 may have the SDRAM 201 built therein.

Furthermore, a reference symbol 321 denotes an operation section interface with respect to the operation section 121A of the personal digital assistance. The user can operate the personal digital assistance by operating the operation section 121A.

The host device 100 can supply a command to the controller 311 via the host interface 312. Furthermore, the host device 100 can receive data from the controller 311 and transfer data to the controller 311 side via the host interface 312.

As commands from the controller 311, there are a data write command, a data readout command, a command for specifying data size, a command for transferring data, a command for reading out memory information, etc. The controller 311 interprets a command from the host device 100, and performs the data write processing, readout processing, transfer processing, etc.

The controller 311 can send and receive data to and from the SDRAM 201 via the SDRAM interface 313. Furthermore, the controller 311 can send and receive data to and from the HD 204 via the disk interface 314. Moreover, the controller 311 can send and receive data to and from the flash memory (which may be simply referred to as cache memory) 203 via the flash memory interface 315. Data to be stored in the flash memory 203 will be stored therein after an error correcting code is added thereto. Also, data to be stored in the hard disk will be stored therein after an error correcting code is added thereto. The ECC processing is performed with respect to recording data to the flash memory and recording data to the hard disk so that the error correction processing can be performed at the time of reproducing data.

In the above-described device, portions of the flash memory interface 315 and flash memory 203 are used as a cache. The flash memory 203 may be referred to as a nonvolatile cache memory.

The order in writing data and order in reading out data are determined according to software stored in the controller 311. For example, when write data is sent from the host device 100 to the HD 204, the data may be sent via a path of host interface 312→controller 311→SDRAM interface 313→SDRAM 201→SDRAM interface 313→controller 311→disk interface 314→hard disk 204. Otherwise, the data may be sent via a path of host interface 312→controller 311→flash memory interface 315→flash memory 203→flash memory interface 315→controller 311→disk interface 314→hard disk 204.

Furthermore, the data may be sent via a path of host interface 312→controller 311→flash memory interface 315→flash memory 203→flash memory interface 315→controller 311→SDRAM interface 313→SDRAM 201→SDRAM interface 313→controller 311→disk interface 314→hard disk 204.

When data is read out from the HD 204 to the host device 100, the data may be read out via a path of HD 204→disk interface 314→controller 311→SDRAM interface 313→SDRAM 201→SDRAM interface 313→controller 311→host interface 312→host device 100. Otherwise, the data may be read via a path of HD 204→disk interface 314→controller 311→flash memory interface 315→flash memory 203→flash memory interface 315→controller 311→host interface 312→host device 100. Furthermore, the data may be read via a path of HD 204→disk interface 314→controller 311→flash memory interface 315→flash memory 203→flash memory interface 315→controller 311→SDRAM interface 313→SDRAM 201→SDRAM interface 313→controller 311→host interface 312→host device 100.

<Explanation for Flash Memory>

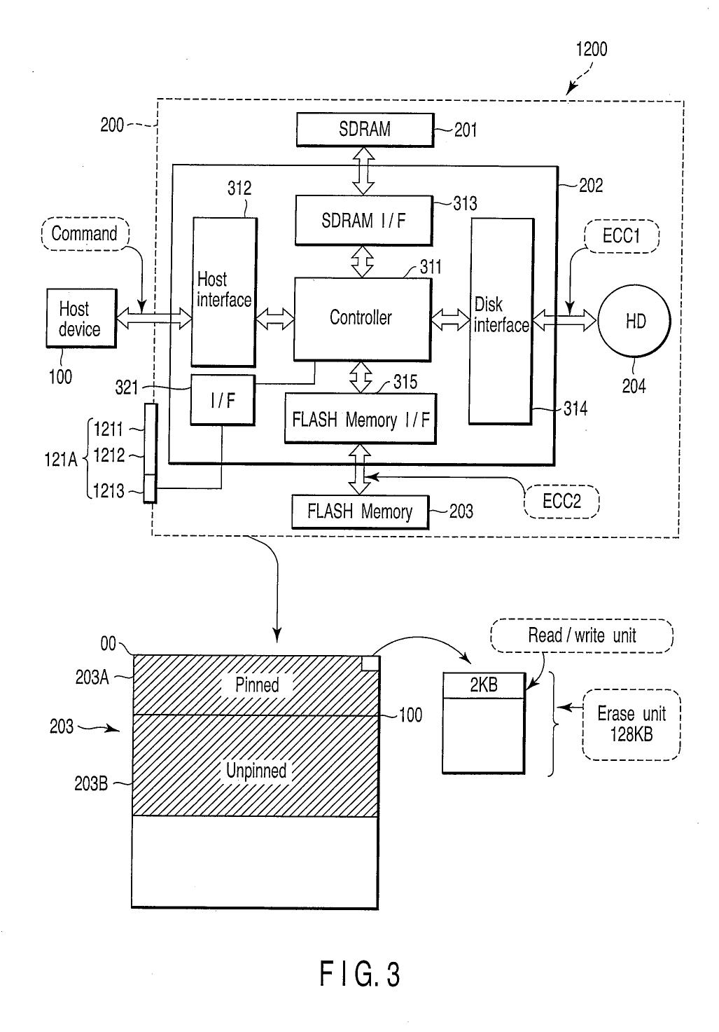

FIG. 3 shows a diagram for explaining the peculiar control operation in dealing with the flash memory 203. While the flash memory 203 is a nonvolatile memory, data stored therein can be electrically erased. Therefore, the flash memory 203 is a nonvolatile memory whose data can be rewritten.

For example, the erase unit of the flash memory 203 is specified to 128 Kbytes. On the other hand, for example, the readout unit and write unit are specified to 2 Kbytes, respectively. The elements of the flash memory 203 are degraded and the number of times of error occurrence increases when the number of times of the erasing operation increases. Therefore, as information which ensures the performance of the elements, the number of times of the rewriting operation is specified to approximately 100,000 times. The number of bytes of the erase unit and the number of bytes of the write unit are not limited to the above-described values. The erase unit may be set to 23 Kbytes, and the write unit may be set to 512 bytes.

<Basic Function and Operation being Prerequisite of Above-Described Device>

Basic Relation Between Flash Memory, Controller, and Command from Host Device

As shown in FIG. 3, when data is written to the flash memory 203, the write area can be classified into a Pinned area 203A and an Unpinned area 203B. The Pinned area 203A is an area which is formed when a command for data write destination sent from the host device 100 purposefully specifies the flash memory 203. The command contains a logical block address (LBA) of the flash memory 203. The Unpinned area 203B is an area where the controller 311 uniquely determines the data transfer destination and data storage destination, and stores data (a) when the data write destination by the host device 100 is not specified by a command, and (b) when the controller 311 is in the basic state.

As data to be written to the flash memory 203, there are data sent from the host device 100 and data read out from the hard disk 204.

There are various types of determination conditions for determining the data write destination by the controller 311. A state determining section in the controller 311 comprehensively determines the conditions of the surroundings and determines the write destination.

In Case of Storing Data from Host Device 100, and in Case of Storing Data in Flash Memory 203 or in SDRAM 201

Immediately after the power of the device is turned on, and in case the HD 204 has not attained a predetermined rotation speed, or the HD 204 is in the stopped state. In this case, it is more convenient to write data to the flash memory 203 or to the SDRAM 201. Furthermore, in case it is desired to transfer data promptly, it is convenient to write data to the flash memory 203 once from the host device 100, and then transfer and rewrite (referred to as write back) the data to the HD 204 when time can be spared.

In Case the Host Device 100 Desires to Use Data of the HD 204 Repeatedly

In this case, it is convenient to read out data of the HD 204, and store thus read out data in the flash memory 203. The reason is that data to be used can be accessed with a high speed when the data is stored in the flash memory 203.

Function and Configuration of Flash Memory Interface 315 and Controller 311

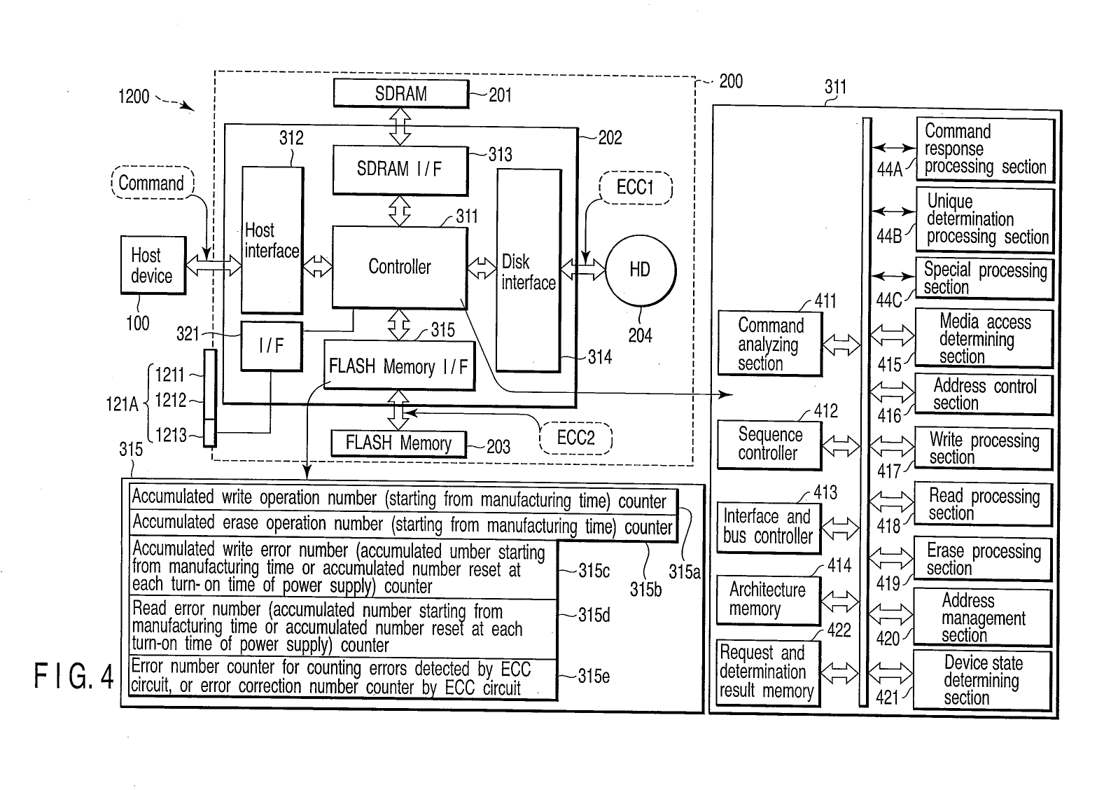

FIG. 4 shows the configuration of the controller 311 and flash memory interface 315, in which parts or components are classified according to the function. The flash memory interface 315 has arranged therein counters. The counters are used to count the number of times of writing data and reading out data to and from the flash memory 203, and the number times of error occurrence, etc.

As counters, there are prepared an accumulated write operation number counter 315a, an accumulated erase operation number counter 315b, an accumulated write error number counter 315c, and a read error number counter 315d. Instead of the read error number counter 315d, an error number counter for counting errors detected by ECC circuit, or an error correction number counter 315e may be arranged. Furthermore, a counter which counts the read/write unit may be arranged. The contents of the above-described counters are utilized as the determination factors for the state determining section which determines whether or not a warning is issued when the number of errors becomes larger.

The controller 311 includes a command analyzing section 411 to decode and analyze a command sent from the host device 100. Software in an architecture memory 414 is specified according to the analysis result for the command, and an operation procedure is set up in a sequence controller 412. Furthermore, these command analysis and control may be performed in the host interface 312.

The sequence controller 412 controls the flow of data and the flow of control data via an interface and bus controller 413. For example, when data is written or read out, a media access determining section 415 specifies the flash memory 203 or hard disk (HD) 204, and an address control section 416 specifies a write address or a read address. Then, a write processing section 417 transfers write data (at the time of writing data). Furthermore, a read processing section 418 transfers read data (at the time of reading out data).

Furthermore, there is arranged an erase processing section 419. The erase processing section 419 erases data of the flash memory 203. Moreover, the erase processing section 419 can erase data of the hard disk 204.

Furthermore, there is arranged an address management section 420. The address management section 420 collectively manages addresses of the hard disk 204 and addresses in the recorded area and unrecorded area of the flash memory 203.

Since the flash memory 203 is used as a cache memory, in case the host device 100 side specifies the address, it is not necessary for the host device to pay attention to the address of the cache memory, and the host device only has to set up the address of the hard disk side.

When the flash memory 203 is specially specified as the data storage destination, the host device 100 only has to issue a Pinned command. In case the Pinned command is not issued, generally, the data storage destination is determined depending on the determination result of firmware established in the controller 311.

The address management and control for the Pinned area and Unpinned area of the flash memory 203 may be performed via the flash memory interface 315.

Furthermore, there is arranged a device state determining section 421. The device state determining section 421 monitors, for example, the state of the hard disk 204.

When the storage capacity of the flash memory 203 becomes larger than a predetermined threshold value, the controller 311 determines the state, and performs the processing of transferring and rewriting data to the hard disk 204. In the operation at this time, mainly, the read processing section 418, write processing section 417, and address management section 420 are combinedly controlled.

Furthermore, in the controller 311, there is arranged a request and determination result memory 422.

The request and determination result memory 422 works as the characterizing portion of the device, as will be explained later. The request and determination result memory 422 may be arranged in any one of the flash memory interface 315, host interface 312, flash memory 203, and operation section interface 321.

### Peculiar Configuration, Function, and Operation in Preset Embodiment

<Prerequisite>

In the above-described storage device, write data from the host device 100 is written to any one of the hard disk 204 and the flash memory 203 under the determination of the controller 311. For example, in case a logical address-block (LAB) for writing data is not specified, the determination about which recording medium data is to be written is entrusted to the determination of the controller 311 (software). Furthermore, under the management of the controller 311, the judgment about whether or not the flash memory 203 is utilized as data cache is also entrusted to the determination of the controller 311 (software).

In case of purposefully writing data to the flash memory 203, a LBA is specially specified. This address specifies the above-described Pinned area, and is referred to as a Pinned LBA. A group of addresses which are not specified by the host device 100 are referred to as Unpinned LBA.

That is, under the basic operation mode, the above-described device conforms to “Non Volatile Cache Command Proposal for ATA8-ACS standard”.

On the other hand, depending on various conditions and environment, when considering the reliability in storing data and reliability in reading out stored data, there may be some cases in which it is desired that data not be written to the hard disk 204.

In general, the flash memory 203, which is not provided with a drive system element, is robust over the impact when being accessed, and requires a small amount of power. On the other hand, an HD drive, in which a head accesses data on the rotating HD via an arm, is fragile with respect to the impact when being accessed, and requires a large amount of power. Under the normal operation mode, while the flash memory is used as a cache memory, in case there is raised a cache miss, or in case data cannot be written to the flash memory 203 for some reason, it is necessary to access the HD. Accordingly, there is brought about a possibility that the HD is consistently accessed, raising time periods during which the HD drive is fragile with respect to the impact, and requires a large amount of power.

In case access restriction to the HD can be performed with respect to a storage device having a cache memory and an HD, it becomes unnecessary to consider these time periods. As one method for the access restriction, in one embodiment according to the present invention, there is arranged a switch (media disable switch) 1213.

The device control with respect to the switch 1213 is as follows. In case a data access command is issued from the host device 100, it is determined whether the flash memory 203 should be accessed or the HD 204 should be accessed. Then, the command analyzing section 411 analyzes the command, and the media access determining section 415 determines the access media in response to the analysis result.

In case of determining to access the flash memory 203, the usual accessing is performed. In case of determining to access the HD 204, the state of the switch 1213 is checked. Then, the device state determining section 421 checks a table of the request and determination result memory 422, and checks the state of the switch 1213.

In case the state of the switch 1213 is off (which means accessing HD is possible), the operation goes to the usual accessing operation, while in case the state of the switch 1213 is on (which means accessing HD is impossible), accessing the HD 204 is not performed.

In the latter case, the following processing is performed.

### Example 1

The storage device 200 sends an access error notice (read error/write error) to the host device 100. When the access error notice is sent, the host device 100 specifies the flash memory 203 as the access destination, and resends an access command to write data.

### Example 2

There may be some cases in which the storage device 200 sends no access error notice (read error/write error) to the host device 100. In these cases, it is checked that the switch 1213 is off, and data is uniquely written to the flash memory 203.

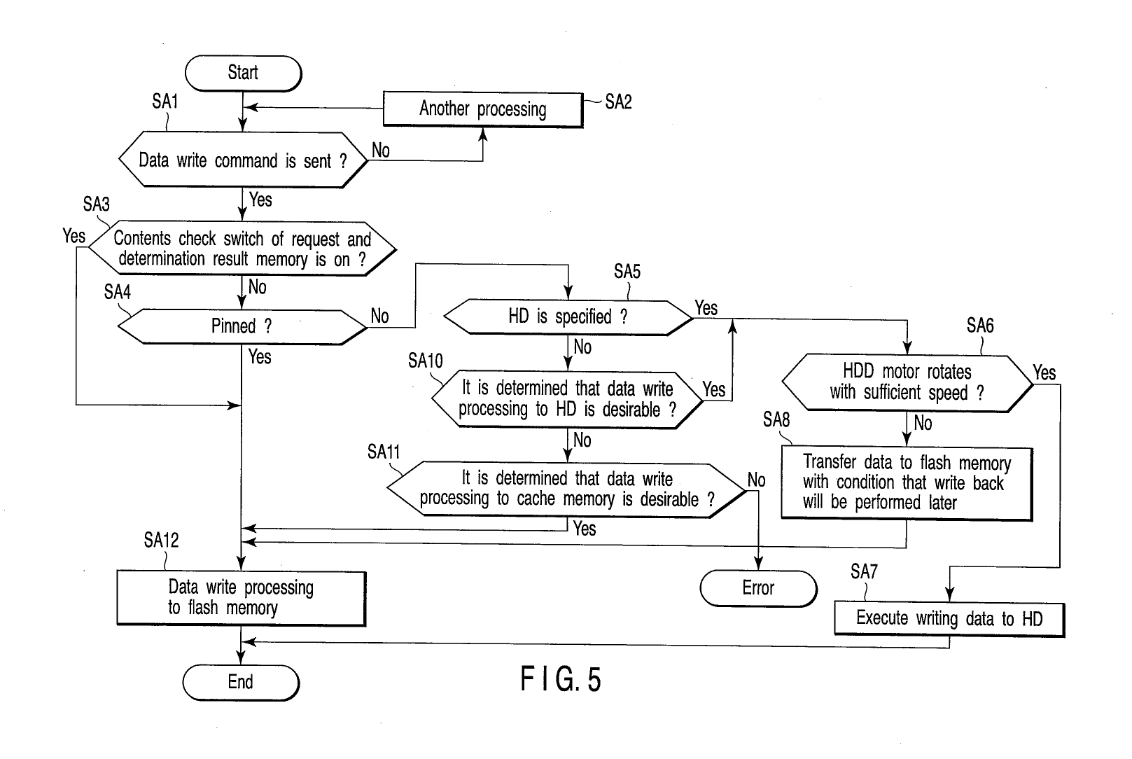

FIG. 5 shows a flowchart indicative of one example of the operation when the device writes data, which processing is to be executed by the controller 311. The command analyzing section 411 analyzes commands sent from the host device 100, and determines whether or not a data write command is sent (step SA1). In case a data write command is not sent, another processing (step SA2) is executed, and the processing returns to step SA1.

In case a data write command is sent, information stored in the request and determination result memory 422 is checked by the device state determining section 421. This information indicates whether the switch 1213 is in the on state or in the off state.

In case the switch 1213 is in the on state, this state indicates that accessing the HD 204 is forbidden. In this case, based on the determination result of the device state determining section 421, the media access determining section 415 specifies the flash memory 203. Then, the controller 311 executes accessing the flash memory 203. That is, the processing goes to step SA12, and data write processing to the flash memory 203 is executed. In step SA3, in case it is determined that the switch 1213 is off, the processing goes to step SA4, and it is judged whether or not the Pinned is specified.

In step SA4, in case it is determined that the Pinned is specified by the media access determining section 415, the processing goes to step SA12, and executes data write processing to the flash memory 203. In step SA4, in case it is determined that the Pinned is not specified, the processing goes to step SA5, and it is determined whether or not the HD 204 is specified. In case it is determined that the HD 204 is specified, the processing goes to step SA6. In this step, the device state determining section 421 determines whether or not the rotation of an HDD (hard disk drive) motor is sufficient. In case the rotation of the HDD motor is sufficient, data write processing to the HD 204 is executed.

In step SA6, in case the rotation of the HDD motor is insufficient, that is, in case it is determined that the HDD motor has not attained a sufficient rotation speed after being started up, setting a condition that the write back will be performed later (step SA8), the processing goes to step SA12, and data write processing to the flash memory 203 is executed.

In case it is determined that the HD 204 is not specified in step SA5, so as to select media, unique determination processing by the device itself is executed. The operation is executed mainly by the media access determining section 415. In this determination (step SA10), in case it is determined that data write processing to the HD 204 is desirable, the processing goes to the former step SA6. In case it is determined that data write processing to the cache memory is desirable (step SA11), the processing goes to step SA12, and data write processing to the flash memory 203 is executed. In step SA11, in case it is determined that data write processing to the cache memory is not desirable, an error (alarm) is displayed. The steps SA4, SA5, SA10, and SA11 are original operation mode (or basic operation mode).

As the determination condition in the step SA10, in case the number of times of error occurrence, or number of error bytes of the flash memory 203 is increased, the HD 204 is selected. Furthermore, in case the data amount of stored data is more than a predetermined amount, or stored data is data which has to be preserved for a long term, the HD 204 is selected. The data amount can be determined using attribute data indicative of data attribute, and can be determined using specification term (data length) information that specifies stored data. Furthermore, whether or not stored data has to be preserved for a long term is selected depending on the type of the data. For example, in case of application data that is temporarily used, the data does not have to be preserved for a long term, while in case of contents data of music, image, etc., the data has to be preserved for a long term.

In this way, the access media is determined by the media access determining section 415. Data writing is executed mainly by the write processing section 417. At this time, an address table of the address management section 420 is referred to, and the address control section 416 specifies an address to be accessed.

Data stored in the flash memory 203 and HD 204 is hierarchically managed on the basis of the file unit and on the basis of the title unit in files. Accordingly, for example, in the address management section 420, the root directory for files is established. Furthermore, in case data is read out, according to the operation from the operation section 121A, read specification on the basis of the file unit or on the basis of the title unit is performed. According to the specification, the read processing section 418 of the controller 311 read data from the flash memory 203 or HD 204 in collaboration with the address management section 420 and address control section 416.

As described above, according to the device of the present invention, the command analyzing section 411, media access determining section 415, device state determining section 421, and request and determination result memory 422 play a key role. In writing data, the operations in collaboration with each other are classified into those of (1) command response processing section 44A, (2) unique determination processing section 44B, and (3) special processing section 44C.

The command response processing corresponds to step SA4 (Pinned response), step SA5, and step SA7 (HD specification response) in FIG. 5. The unique determination processing corresponds to step SA10 and step SA11 in FIG. 5. The special processing corresponds to step SA3 and step SA12 in FIG. 5. In FIG. 5, so as to make the functions comprehensible, (1) command response processing section 44A, (2) unique determination processing section 44B, and (3) special processing section 44C are shown. On the other hand, actually, the respective blocks of the command analyzing section 411, media access determining section 415, device state determining section 421, and request and determination result memory 422 are realized in collaboration with each other.

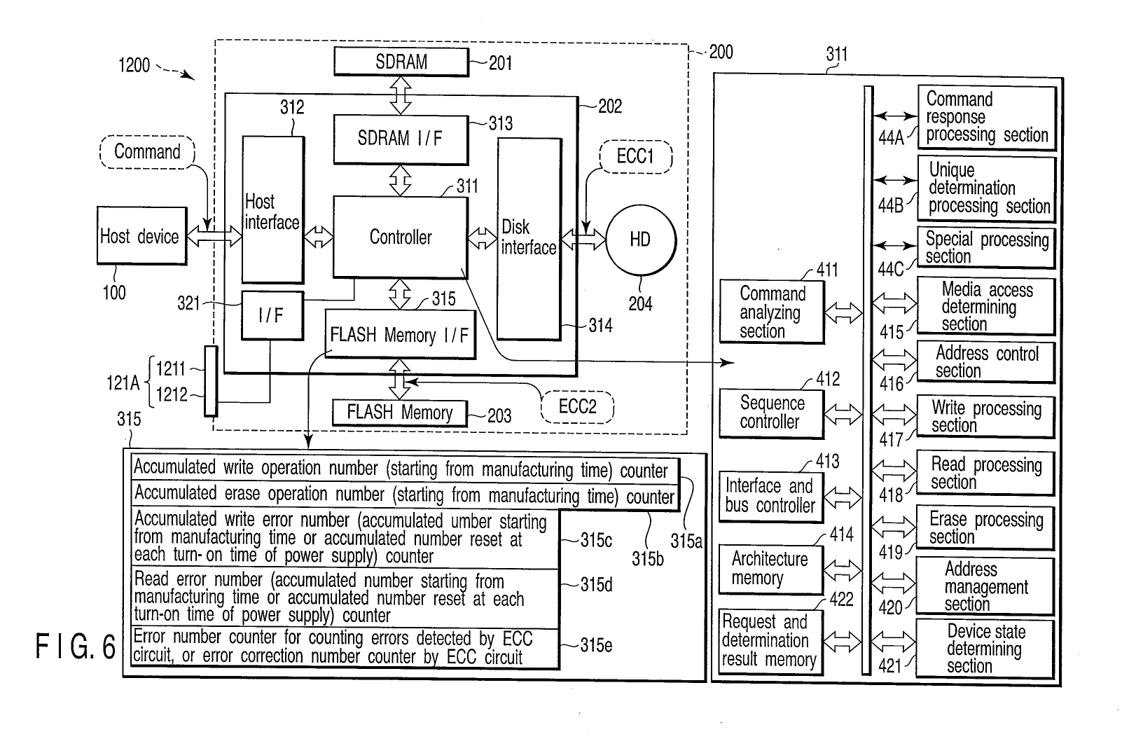

FIG. 6 shows the configuration of another embodiment according to the resent invention. In the embodiment shown in FIG. 4, so as to forbid writing data to the hard disk 204, the switch 1213 which is manually operated is utilized. On the other hand, when transferring data from the host device 100, a restriction may be imposed on writing data. In this case, there may be employed a method of supplying a command parameter (indicating that writing to HD is forbidden or permitted) to the storage device 200 side from the host device 100, or a method of supplying a direct HD write forbiddance/permission command.

FIG. 6 shows an embodiment of a case of supplying a parameter indicating that writing to HD is forbidden or permitted to the storage device 200 side from the host device 100, or a case of supplying a direct HD write forbiddance/permission command.

The command analyzing section 411 extracts parameters in a specified region from the write command sent from the host device 100, and stores thus extracted parameters in the request and determination result memory 422. The parameters are equal with data indicative of the state of the switch 1213, as has been described in the former embodiment. For example, in case of indicating that the switch 1213 is off, a parameter “0000” is determined, while in case of indicating that the switch 1213 is on, a parameter “1010” is determined. The case of the HD write forbiddance/permission command is similar, and in case of indicating that the switch 1213 is off, a parameter “0000” is determined, while in case of indicating that the switch 1213 is on, a parameter “1010” is determined.

Before selecting media and executing data write processing, the storage device 200 checks the contents of the request and determination result memory 422, and operates in accordance with the flowchart shown in FIG. 5.

This invention is not restricted to the above-described embodiments, and there may be employed a configuration in which both the functions of the device shown in FIG. 4 and the functions of the device shown in FIG. 6 are provided. That is, to the request and determination result memory 422, information may be input using hardware or the switch 1213, or information may be input from the host device 100.

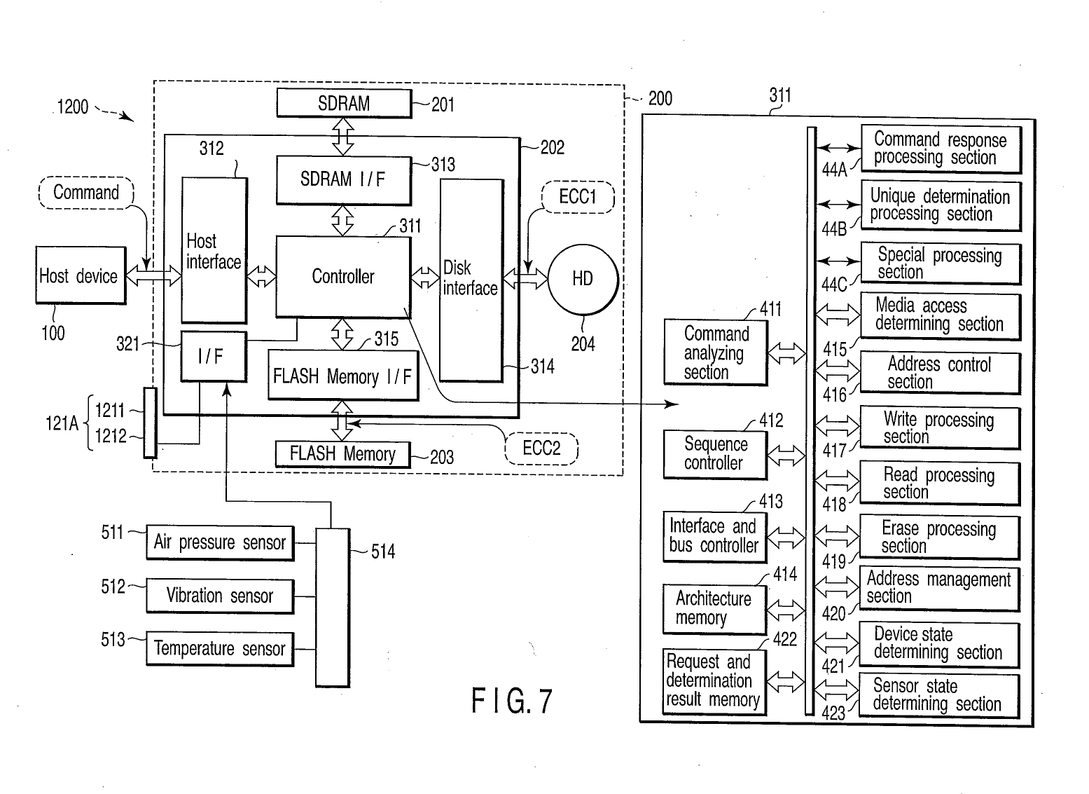

FIG. 7 shows the configuration of yet another embodiment according to the present invention. The present invention is not restricted to the above-described embodiments. As environment sensors, an air pressure sensor 511, a vibration sensor 512, or a temperature sensor 513, or the combination thereof may be arranged. The response output of the air pressure sensor 511, vibration sensor 512, and temperature sensor 513 is amplified to be converted to data of a predetermined format by a signal converter 514. Thus converted data is input to the controller 311 via the operation section interface 321. The controller 311 determines the response state of the sensors. When set up conditions are satisfied, the controller 311 sets up information indicating that writing to HD is forbidden or permitted with respect to the request and determination result memory 422.

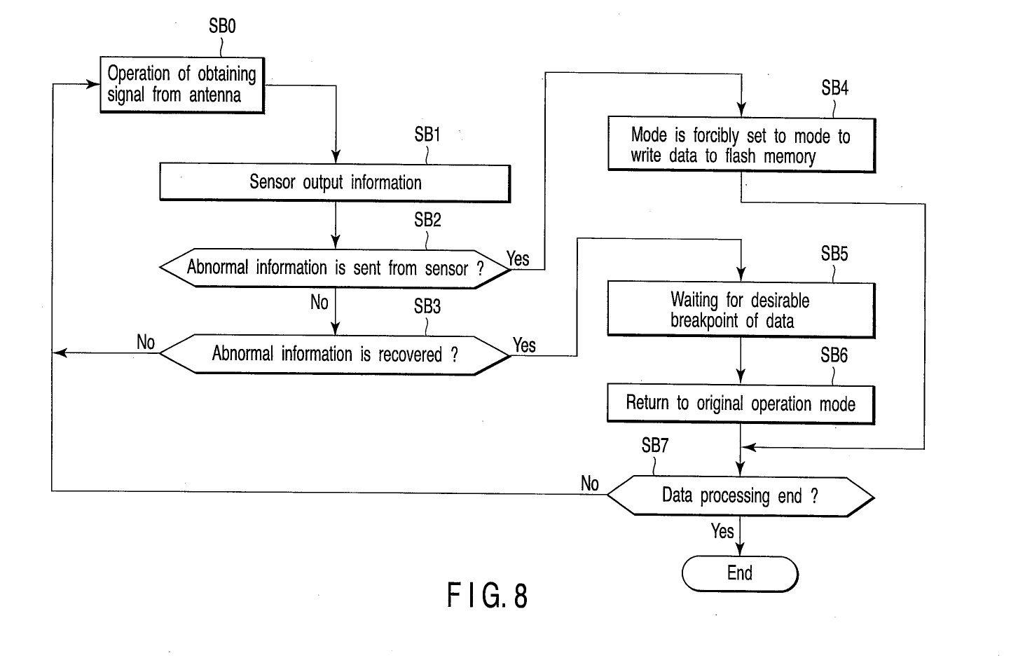

FIG. 8 shows a flowchart indicative of one example of the operation in the embodiment shown in FIG. 7. For example, sensor output information is periodically checked by a sensor state determining section 423 of the controller 311 (step SB1). Then, it is determined whether or not information indicative of environmental abnormality is sent from the sensor (step SB2). In case there is no environmental abnormality, it is determined whether or not the environment is in the state immediately after being recovered from environmental abnormality to environmental normality (step SB3). In case the environment is not in the state immediately after being recovered to environmental normality, the processing returns to step SB1 via step SB0. Step SB0 indicates an operation mode under which the storage device 200 obtains a signal from an antenna.

In step SB2, in case information indicative of environmental abnormality is sent from the sensor, the processing goes to step SB4, and the mode is forcibly made to come into a mode of writing data to the flash memory 203. Then, it is determined whether or not the data processing ends (step SB7), and in case the data processing ends, this flow ends. In case the data processing does not end, the processing returns to step SB1 via step SB0.

In step SB2, in case information indicative of environmental abnormality is not sent from the sensor, and, in step SB3, in case the environment is in the state immediately after being recovered from environmental abnormality to environmental normality, the processing goes to step SB5. In step SB5, waiting for a desirable breakpoint of input data by buffering, then recording input data is started. The recording media at this time is equal with that in the selection operation in the original operation mode (step SB6). In the original operation mode, the device itself uniquely selects recording media, which corresponds to the routine of steps SA4, SA5, SA10, SA11, SA6, SA7, and SA8 in FIG. 5.

That is, in case the Pinned is specified, data is written to the flash memory 203. In case the Pinned is not specified, for example, along the flowchart shown in FIG. 5, data is written to the hard disk 204 or flash memory 203.

As described above, the operation of utilizing output information of the sensors is effective in a situation in which the personal digital assistance 1200 shown in FIG. 1 takes in data via radio transmission. The personal digital assistance 1200 has an antenna, and can download music information, image information, etc. using radio waves being media. In case of the personal digital assistance 1200, the user often carries around and uses the personal digital assistance 1200. When used under the situation, in case the personal digital assistance 1200 is dropped down, or used at a place where the humidity is abnormally high, or a place having a lot of moisture, data recorded in the hard disk 204 becomes unstable. Accordingly, under such use environment, the output state of the sensors is monitored, and the device is configured such that accessing the hard disk 204 can be forbidden. In this way, the reliability of the device is improved.

When the sensor detects the environmental abnormality, in step SB5 of FIG. 8, write error processing may be performed to reattempt the processing of taking in data with a predetermined unit from the beginning.

When the output of the air pressure sensor 511 is utilized, the device is set up such that, in case the air pressure is in a range from a predetermined value A1 to a predetermined value B1, it is determined that there is no environmental abnormality. In case the air pressure is not in the range, it is determined that there is environmental abnormality. Furthermore, when the output of the vibration sensor 512 is utilized, the device is set up such that, in case the acceleration is in a range from a predetermined value A2 to a predetermined value B2, it is determined that there is no environmental abnormality. In case the acceleration is not in the range, it is determined that there is environmental abnormality. Moreover, when the output of the temperature sensor 513 is utilized, the device is set up such that, in case the temperature is in a range from a predetermined value A3 to a predetermined value B3, it is determined that there is no environmental abnormality. In case the temperature is not in the range, it is determined that there is environmental abnormality.

The present invention is not restricted to the above-described embodiments. There may be employed an embodiment that combines the embodiment shown in FIG. 7 and the embodiment shown in FIG. 4, or an embodiment that combines the embodiment shown in FIG. 7 and the embodiment shown in FIG. 6.

According to the use environment, the embodiment using the sensors shown in FIG. 7 and the embodiment shown in FIG. 4 or FIG. 6 may be switched. The device according to the present invention is effective especially when a signal is obtained from an antenna.

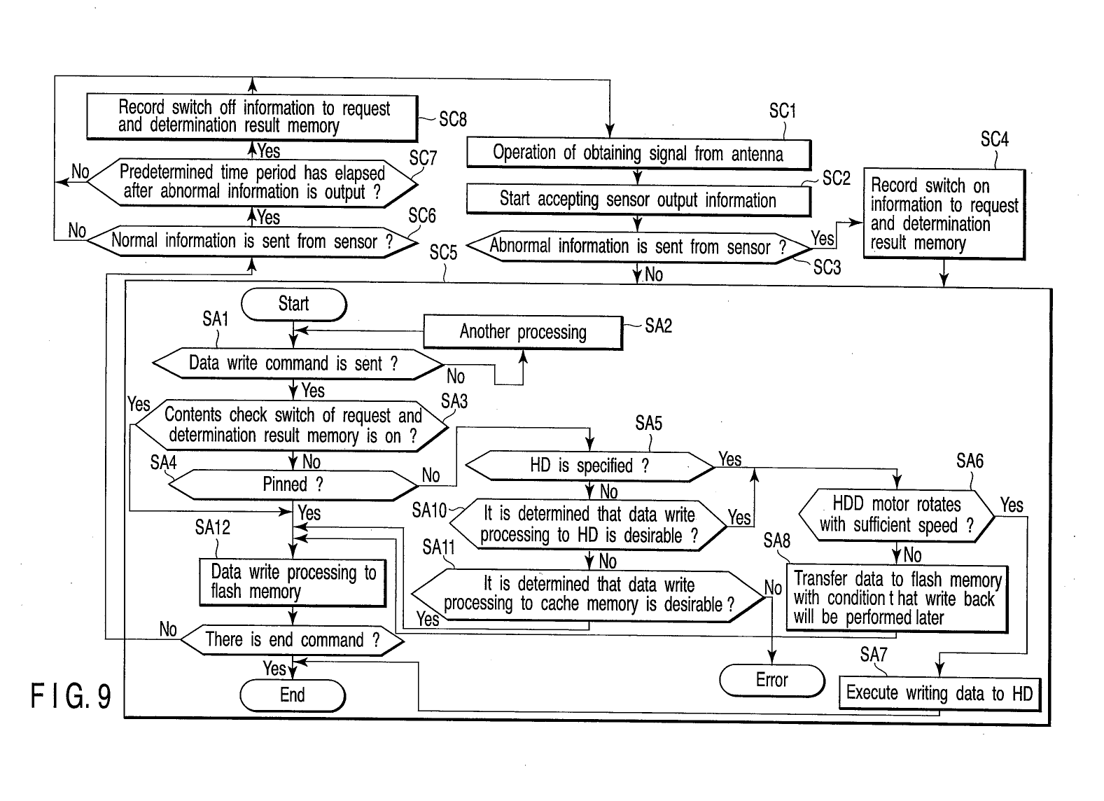

In the embodiment shown in FIG. 7, there is a possibility that the operation mode is frequently switched. Accordingly, the operation flow of the media access determining section 415 may be set up as shown in FIG. 9.

As shown in FIG. 9, in step SC1, when obtaining a signal from an antenna is started, accepting sensor output information is started (step SC2). In case abnormal information is sent from the sensor (step SC3), request and determination result memory switch on information is recorded. Then, the processing goes to the flowchart shown in FIG. 5. In FIG. 9, the entire flowchart shown in FIG. 5 is represented as step SC5. In step SC3, in case abnormal information is not sent from the sensor, the processing directly goes to step SC5.

In data write processing step SA12, in case there is not an end command, the processing goes to step SC6. In this step, it is determined whether or not normal information is output from the sensors. In case normal information is not output, steps SC1, SC2, SC3, and SC4 are processed, and, as shown in FIG. 5, data is written to the flash memory 203.

In step SC6, in case normal information is output from the sensors, the processing goes to step SC7. In step SC7, it is determined whether or not a predetermined time period (for example, five minutes) has elapsed after the previous abnormal information is output. In case a predetermined time period has elapsed, the processing goes to step SC8, and it is determined that the state is changed from the abnormal state to the normal state, and switch information of the request and determination result memory 422 is turned off. Accordingly, the device comes into the basic operation mode.

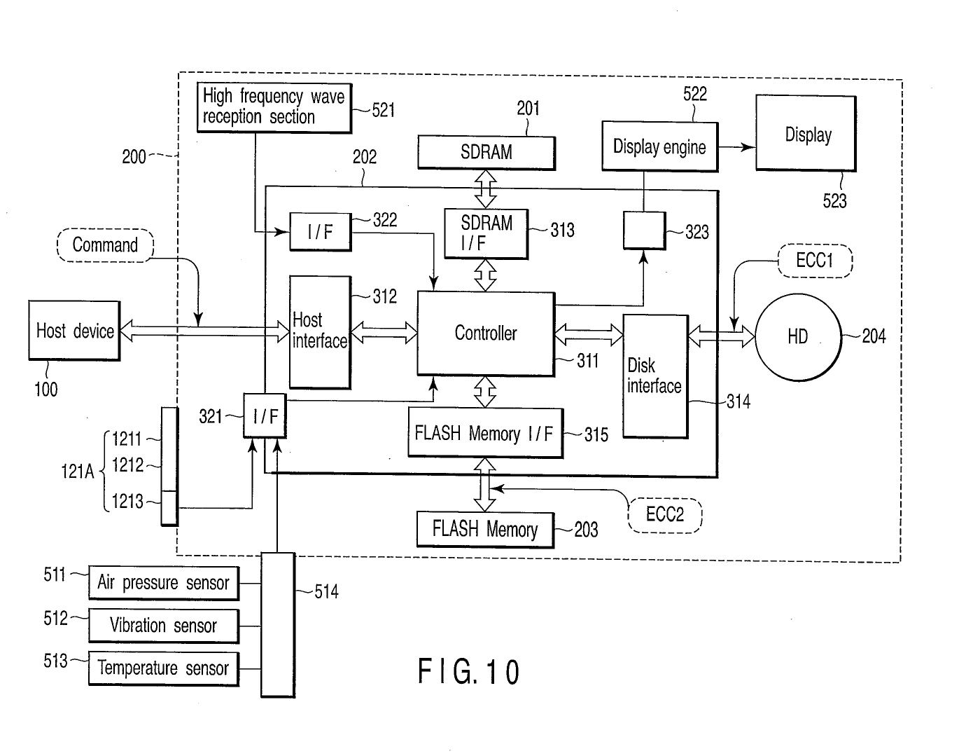

FIG. 10 shows an embodiment that combines the configurations shown in FIG. 4, FIG. 6, and FIG. 7, and a high frequency wave reception section and a display are arranged. That is, a signal received by a high frequency wave reception section 521 including an antenna can be sent to the controller 311 via an interface 322 to be stored in the recoding medium. The storage rule is similar to that which has been described in the above-described embodiments. Data read out from the recording medium is buffered to a display engine 522 via the controller 311 and an interface 323. Then, data for display from the display engine 522 is input to the display 523. This device further has mounted thereon a music reproduction block.

The above-described device can be utilized as an audio player, an image reproduction device, a game machine, etc. of portable type. Furthermore, by adding applications, the above-described device can be utilized as a personal electronic databook, a personal electronic notebook, etc.

In the above-described explanation, the host device 100 and the storage device 200 are separately arranged. On the other hand, there may be employed a personal device in which the host device 100 and the storage device 200 are unitedly arranged. That is, there may be configured a device whose components are enclosed by a dashed line in FIG. 2. In this case, the output of the air pressure sensor 511, vibration sensor 512, and temperature sensor 513 may be processed in the host device 100, the processing result of which is sent to the controller 311. Furthermore, the output of the high frequency wave reception section 521 and operation section 121A may be processed in the host device 100.

While certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device using a nonvolatile cache memory, comprising:
a host interface connected to a host device;
a hard disk interface for hard disk;
a cache memory interface connected to a cache memory;
a command analyzing section which analyzes the contents of a command input from the host interface;
a memory which stores request information indicative of “forbiddance” or “permission” with respect to accessing the hard disk;
a device state determining section which, before responding to the command analyzed by the command analyzing section, determines the request information of the memory; and
a media access determining section;
wherein the media access determining section includes
a first section which forbids accessing the hard disk and sets up only accessing the cache memory, when the device state determining section makes a determination of the “forbiddance”, and
a second section which determines the access destination to the hard disk or cache memory based on the analysis result of the command analyzing section or unique determination result of this second section, when the device state determining section makes a determination of the “permission”.

2. The storage device using a nonvolatile cache memory according to claim 1, wherein the request information of the memory is supplied from an external operation switch.

3. The storage device using a nonvolatile cache memory according to claim 1, wherein the memory takes in and stores the request information when the request information is sent from the host device.

4. The storage device using a nonvolatile cache memory according to claim 1, further comprising:
environment sensors; and
a sensor state determining section which determines whether or not the output information of the environment sensors indicates the environmental abnormality;
wherein the memory stores the request information indicative of the “forbiddance” in case the sensor state determining section makes a determination of the environmental abnormality, while storing the request information indicative of the “permission” in case the sensor state determining section determines that the environment is in the environmental normality.

5. The storage device using a nonvolatile cache memory according to claim 1, further comprising:
a high frequency wave reception section;
environment sensors; and
a sensor state determining section which determines whether or not the output information of the environment sensors indicates the environmental abnormality;
wherein, when data from the high frequency wave reception section is taken into a controller, the memory stores the request information indicative of the “forbiddance” in case the sensor state determining section makes a determination of the environmental abnormality, while storing the request information indicative of the “permission” in case the sensor state determining section determines that the environment is in the environmental normality.

6. The storage device using a nonvolatile cache memory according to claim 5, wherein the memory stores the request information indicative of the “forbiddance” in case the sensor state determining section makes a determination of the environmental abnormality, and further performs a retry via the high frequency wave reception section.

7. A control method of a storage device using a nonvolatile cache memory, the storage device including a host interface connected to a host device, a hard disk interface connected to a hard disk, a cache memory interface connected to a cache memory, a command analyzing section which analyzes the contents of a command input from the host interface, a memory, a device state determining section, and a media access determining section, comprising the steps of:
storing request information indicative of “forbiddance” or “permission” with respect to accessing the hard disk in the memory;
forbidding accessing the hard disk and setting up only accessing the cache memory, by the media access determining section, when the device state determining section makes a determination of the “forbiddance”; and
determining the access destination to the hard disk or cache memory based on the analysis result of the command analyzing section and unique determination result, by the media access determining section, when the device state determining section makes a determination of the “permission”.

8. The control method of a storage device using a nonvolatile cache memory according to claim 7, wherein the request information is supplied from an external operation switch.

9. The control method of a storage device using a nonvolatile cache memory according to claim 7, wherein the request information is supplied from the host device.

10. The control method of a storage device using a nonvolatile cache memory according to claim 7, wherein the memory stores the output information of environment sensors indicative of whether or not the environment is of the environmental abnormality as request information.

11. The control method of a storage device using a nonvolatile cache memory according to claim 7, wherein, when data from a high frequency wave reception section is taken into a controller, the request and determination result memory stores the output information of environment sensors indicative of whether or not the environment is of the environmental abnormality as request information.

12. The control method of a storage device using a nonvolatile cache memory according to claim 11, wherein the request and determination result memory stores the request information indicative of the “forbiddance” with respect to accessing the hard disk in case a determination of the environmental abnormality is made, and further a retry is performed via the high frequency wave reception section.
